(19) United States
(12) Patent Application Publication
(10) Pub. No.: US 2010/0076599 A1
(43) Pub. Date: Mar. 25, 2010

(54) MANUALLY DRIVEN DETERMINATION OF A REGION OF INTEREST (ROI) OR A PATH OF INTEREST (POI) FOR A ROBOTIC DEVICE

(76) Inventors: Steven Jacobs, Monterey, CA (US); Kipp Knutson, Shorewood, MN (US); David Wood, Maple Plain, MN (US)

Correspondence Address: AVERILL & VARN, 8244 PAINTER AVE., WHITTIER, CA, 90602, US

(21) Appl. No.: 12/234,633

(22) Filed: Sep. 20, 2008

(51) Int. Cl. B25J 19/02; B25J 9/22

(52) U.S. Cl. 700/258; 700/264; 901/1; 901/46

(57) ABSTRACT

A robotic device is manually driven along a perimeter of a Region Of Interest (ROI) or along a Path Of Interest (POI) for future autonomous operation. An Initial Point (IP) is established by identifying a unique machine recognizable feature, for example, a Radio Frequency Identification (RFID) tag located at the IP. The robotic device is then manually driven along the perimeter or along the path and sensors carried by the robotic device collects data to characterize the ROI or POI. The sensors may include sonar, vision systems, laser, or radar devices for measuring relative positions of a wall, stairs, or obstacles. Wheel odometry may be used to track distances traveled and data fusion exercised to combine the odometry data with the sonar and/or laser measurements to model the ROI or POI. Characterization is performed by collecting points along a wall, fitting a line to the points, and finding the intersections of consecutive lines.

### BACKGROUND OF THE INVENTION

The present invention relates to robotic device navigation and in particular to a system and method for establishing a map of a Region Of Interest (ROI) or a Path Of Interest (POI) for operation of a robotic device.

Various mobile robotic devices are coming into common use and the use of robotic devices has been suggested for many applications. One such suggested application is the operation of floor cleaning machines for large areas. Another suggested application would be for the operation of a courier robot. Such areas require definition before the robotic device may perform an autonomous operation.

### BRIEF SUMMARY OF THE INVENTION

The present invention addresses the above and other needs by providing a method and robotic device which is manually driven along a perimeter of a Region Of Interest (ROI) or along a Path Of Interest (POI) for future autonomous operation. Manually driven is herein intended to mean controlled by an operator maneuvering the machine physically using onboard the machine controls or remotely controlling the machine. An Initial Point (IP) is established by identifying a unique machine recognizable feature, for example, a Radio Frequency Identification (RFID) tag located at the IP, or by identifying a room geometry. The robotic device is then manually driven along the perimeter or along the path and sensors carried by the robotic device collect data to characterize the ROI or POI. The sensors may include sonar, radar, vision systems, flash lidar, laser, or other distance measuring devices for measuring relative positions of walls, stairs, openings, or obstacles. Wheel odometry may be used to track distances traveled and data fusion exercised to combine the odometry data with the measurements from the distance sensors to model the ROI or POI. Characterization is performed by collecting points along a wall or along a path, fitting a line to the points, and finding the intersections of consecutive lines.

In accordance with one aspect of the invention, there is provided a method for characterizing a Region Of Interest (ROI) for future autonomous operation of a robotic device. The ROI includes a number N boundaries. The method includes positioning the robotic device at an Initial Point (IP) proximal to a location identifying tag or machine recognizable feature residing along a first boundary of the ROI and then manually driving the robotic device along the perimeter of the ROI. The robotic device is manually turned to a first heading approximately parallel to the first boundary and manually driven along the first heading approximately parallel to the first boundary. The robotic device automatically collects a set of first data points corresponding to points along the first boundary using a position and a heading of the robotic device and at least one distance measuring sensor carried by the robotic device. The robotic device is manually turned at a first boundary end towards a second heading approximately parallel to a second boundary of the ROI and the robotic device automatically fits a first line to the set of first data points. The robotic device is then manually driven along the second heading approximately parallel to the secondary boundary and automatically collects a set of second data points corresponding to points along the second boundary using the position and the heading of the robotic device and the at least one distance measuring sensor carried by the robotic device. The robotic device is then manually turned at a second boundary end towards a third heading approximately parallel to a third boundary and the robotic device automatically fits a second line to the set of second data points and automatically sets a first corner position to the intersection of the first line and the second line. The robotic device is then manually driven along the third heading approximately parallel to the third boundary. The robotic device is then manually driven along remaining boundaries of the ROI, collecting data points, fitting lines, and setting corners. The characterization of the ROI is saved for later autonomous operation of the robotic device.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a Region Of Interest (ROI) for operation of a robotic device and a path for manually driving the robotic device along boundaries of the ROI to characterize the ROI according to the present invention for later autonomous operation.

FIG. 2 shows the robotic device next to a boundary of the ROI.

FIG. 3A shows the robotic device next to a location identifying tag on a first boundary of a ROI with the robotic device on a first heading approximately parallel to the first boundary.

FIG. 3B shows the robotic device after manually driving to a first boundary end and turning to a second heading approximately parallel to a second boundary and a first line fit to first data points collected along the first boundary.

FIG. 3C shows the robotic device after manually driving to a second boundary end and turning to a third heading approximately parallel to a third boundary and a second line fit to second data points collected along the second boundary and a first corner position at an intersection of the first line and the second line.

FIG. 3D shows the robotic device after manually driving to a third boundary end and turning to a fourth heading approximately parallel to a fourth boundary and a third line fit to third data points collected along the third boundary and a second corner position at an intersection of the second line and the third line.

FIG. 3E shows the robotic device after manually driving to a fourth boundary end and turning towards the first heading approximately parallel to the first boundary and a fourth line fit to fourth data points collected along the fourth boundary and a third corner position at an intersection of the third line and the fourth line and a fourth corner position at an intersection of the fourth line and the first line.

FIG. 4 is a method according to the present invention for characterizing the ROI for future autonomous operation of the robotic device.

FIG. 5 shows a path around an ROI including free run segments.

FIG. 6 shows a path along a POI including free run segments.

FIG. 7 shows an avoided area comprising an island.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

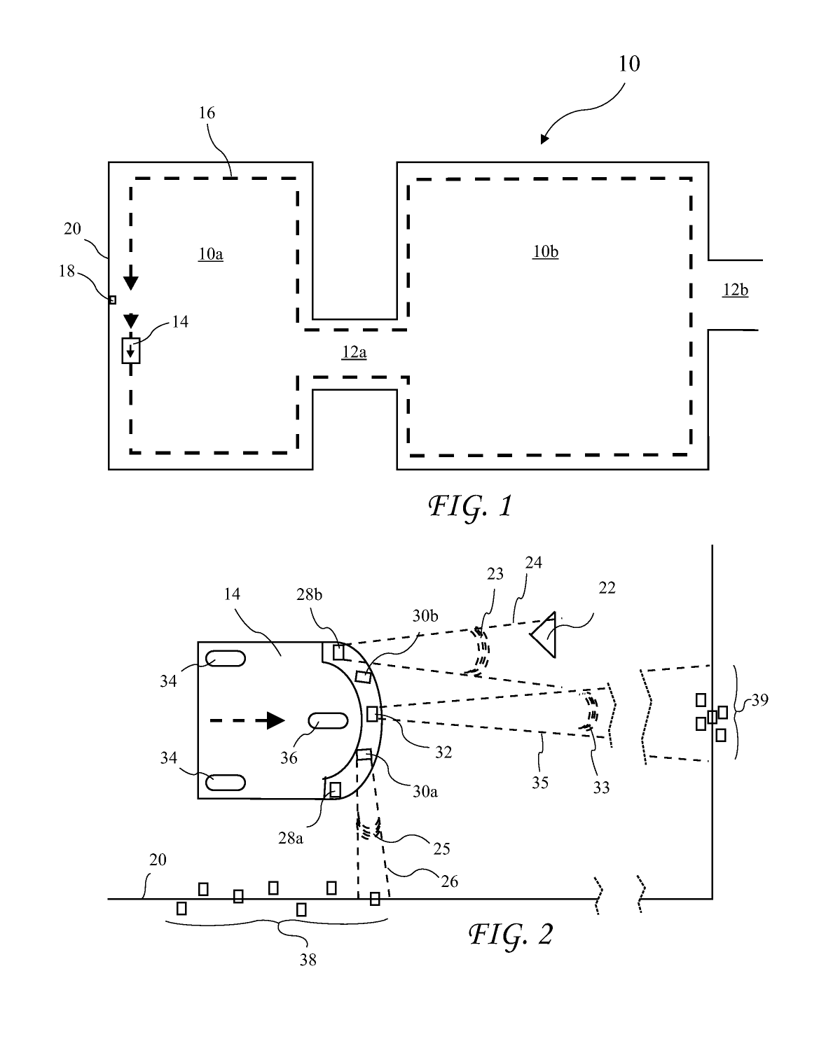

A Region Of Interest (ROI) 10 for operation of a robotic device 14 and a path 16 for manually driving the robotic device 14 along boundaries 20 of the ROI 10 to characterize the ROI 10 according to the present invention for later autonomous operation is shown in FIG. 1. The ROI 10 includes a first room 10a, a hall 12a, and a second room 10b. A second hall 12b is present but is not part of the ROI 10. A location identifying tag 18 resides along the boundary 20 at an Initial Point (IP) for both identifying the location of the IP and for identifying the particular ROI 10 for future identification. The characterization is manually performed by an operator manually driving the robotic device 14 around a perimeter of the ROI 10 along the path 16.

A detailed view of a suitable robotic device 14 and a boundary 20 is shown in FIG. 2. The robotic device 14 has at least two wheels, and preferably has three wheels. A preferred robotic device has two rear wheels 34 and one front wheel 36 and more preferably has a steerable driven front wheel 36 and two non-driven rear wheels 34. One example is the Nilfisk-Advance, Inc. Advenger floor cleaning machine. Each wheel 36 and 34 preferably includes a rotation counter and more preferably an encoder for accurately measuring the rotation of the wheels 36 and 34. Such measurements may be used both to determine a distance traveled by the robotic device 14 (i.e., wheel odometry) and/or to determine a heading of the robotic device, for example, by comparing the relative rotation of the two rear wheels 34.

The robotic device 14 further includes distance measuring sensors 28a, 28b, 30a, 30b, and 32 for characterizing the ROI 10 and for object avoidance during autonomous operation. During ROI 10 characterization, side looking sensors 30a and 30b transmit a wave packet 25 on a beam 26 to measure a distance to the boundary 20. The distance is computed as the propagation speed of the wave packet 25 divided by half a measured round trip propagation time. The reflecting surface is assumed to be in the center of the beam. The distance is combined with the robotic device 14 position and heading to determine data points 38 along the boundary. Additionally, data points 39 made by the forward looking sensor 32 may be saved and in some instances used as data points in the line fit for the boundary they fall on. Forward looking sensors 28a and 28b may provide additional data points for subsequent line fits, and may be used for obstacle avoidance during later autonomous operation of the robotic device 14.

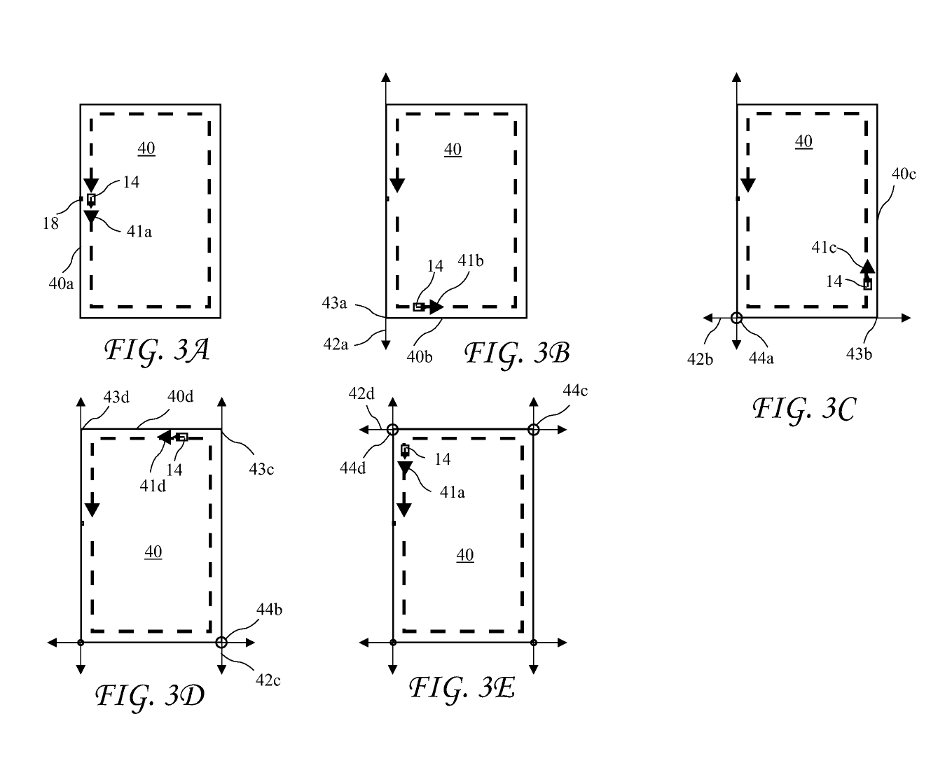

The robotic device 14 is shown next to the location identifying tag 18 on a first boundary 40a of a rectangular ROI with the robotic device 14 on a first heading 41a approximately parallel to the first boundary 40a in FIG. 3A. The location identifying tag 18 is preferably an RFID tag and both identifies a start point and a unique ROI, but the robotic device 14 may also use it's sensors to identify a unique feature in the ROI. Approximately parallel is meant to be parallel within the context of a typical driver. The robotic device does not rely on being driven on a perfectly parallel path to accurately detect points along a wall.

The robotic device 14 is manually driven along a heading 41a approximately parallel to the first boundary 40a to a first boundary end 43a and turned to a second heading 41b approximately parallel to a second boundary 40b shown in FIG. 3B. After turning a sufficient amount at the first boundary end 43a to detect that the robotic device 14 is being turned to a new heading, preferably turning approximately twenty degrees, a first line fit 42a is performed using first data points 38 (see FIG. 2) collected along the first boundary 40a. The line fit 42a may be a linear regression, a least squares line fit, a recursive least squares fit, or any method for fitting a line to data points. The line fit 42a may be computed before completing the turn to the second heading 41b.

The robotic device 14 is then manually driven along the second heading 41b to a second boundary end 43b and turned to a third heading 41c approximately parallel to a third boundary 40c shown in FIG. 3C. After turning a sufficient amount, a second line fit 42b is performed using second data points 38 (see FIG. 2) collected along the second boundary 40b. After computing the second line fit 42b, a first detected corner 44a is computed as the intersection of the first line fit 42a and the second line fit 42b. The detected corner 44a theoretically is co-located with the first boundary end 43a, but may include some error due to inexact line fits. Such errors are generally small.

The robotic device 14 is manually driven on the third heading 41c to a third boundary end 43c and turned to a fourth heading 41d approximately parallel to a fourth boundary 40d shown in FIG. 3D. After turning a sufficient amount, a third line fit 42c is performed using third data points 38 (see FIG. 2) collected along the third boundary 40c. After computing the third line fit 42c, a second detected corner 44b is computed as the intersection of the second line fit 42b and the third line fit 42c.

The robotic device 14 is manually driven to a fourth boundary end 43d and turned towards the first heading 41a approximately parallel to the first boundary 40a shown in FIG. 3E. After turning a sufficient amount, a fourth line fit 42d is performed using fourth data points 38 (see FIG. 2) collected along the fourth boundary 40d. After computing the fourth line fit 42d, a third detected corner 44c is computed as the intersection of the third line fit 42c and the fourth line fit 42d, and a fourth detected corner 44d is computed as the intersection of the fourth line fit 42d and the first line fit 42a. While the example of the present invention is described above in terms of a rectangular room, the ROI may be an area of a room having less than four walls or more than four walls as in the case of FIG.1

FIGS. 3A-3E describe the present invention exercised on a rectangular ROI 40. The application of the present invention to ROIs such as the ROI 10 shown in FIG. 1 follows the same steps as shown in FIGS. 3A-3E. The process of computing line fits and finding corners is entirely automatic and performed without operator inputs, however, in ROIs with boundaries having less than twenty degrees difference, an operator input may be provided to define when a turn is initiated and completed. In ROIs with rounded boundaries, a circle fit may be used to model the rounded boundary(s).

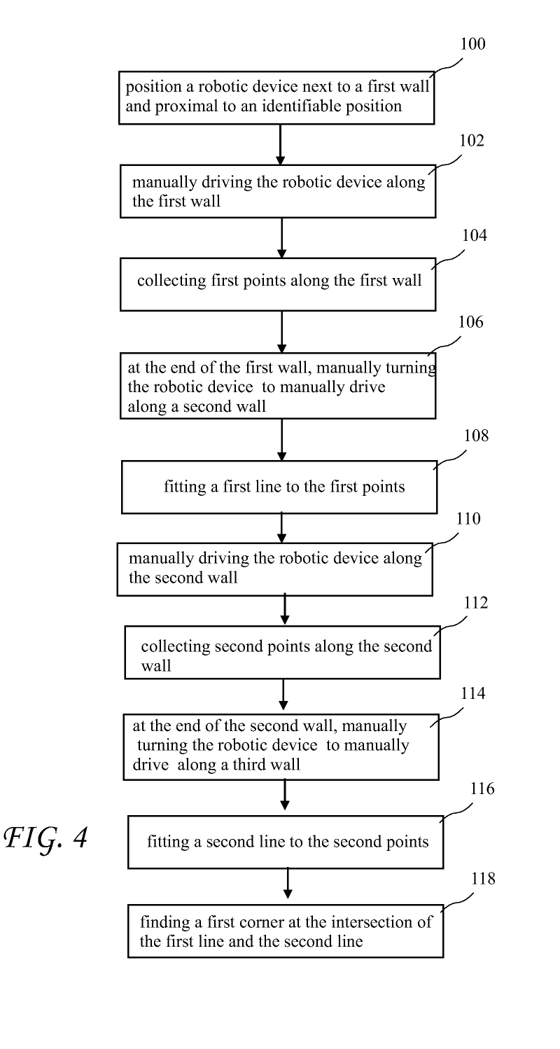

A method according to the present invention for characterizing the ROI for future autonomous operation of the robotic device 14 is described in FIG. 4. The method includes positioning a robotic device next to a first wall and proximal to an identifiable position at an Initial Point (IP) at step 100, manually driving the robotic device along the first wall (or boundary) at step 102, automatically collecting first points along the first wall at step 104, at the end of the first wall, manually turning the robotic device to manually drive along a second wall at step 106, automatically fitting a first line to the first points at step 108, manually driving the robotic device along the second wall at step 110, automatically collecting second points along the second wall at step 112, at the end of the second wall, manually turning the robotic device to manually drive along a third wall at step 114, automatically fitting a second line to the second points at step 116, and automatically finding a first corner at the intersection of the first line and the second line at step 118. In the case of an ROI, the steps 110 to 118 are repeated until the robot device turns toward the IP. When the robotic device is manually turned towards the IP, in addition to automatically fitting the last line to the last wall and automatically finding the previous corner, the final corner is also automatically found. The identifiable position may be identified by detection a position identifying tag, using sensors on the robotic device to identify features in the ROI, or my any other means to identify a particular location.

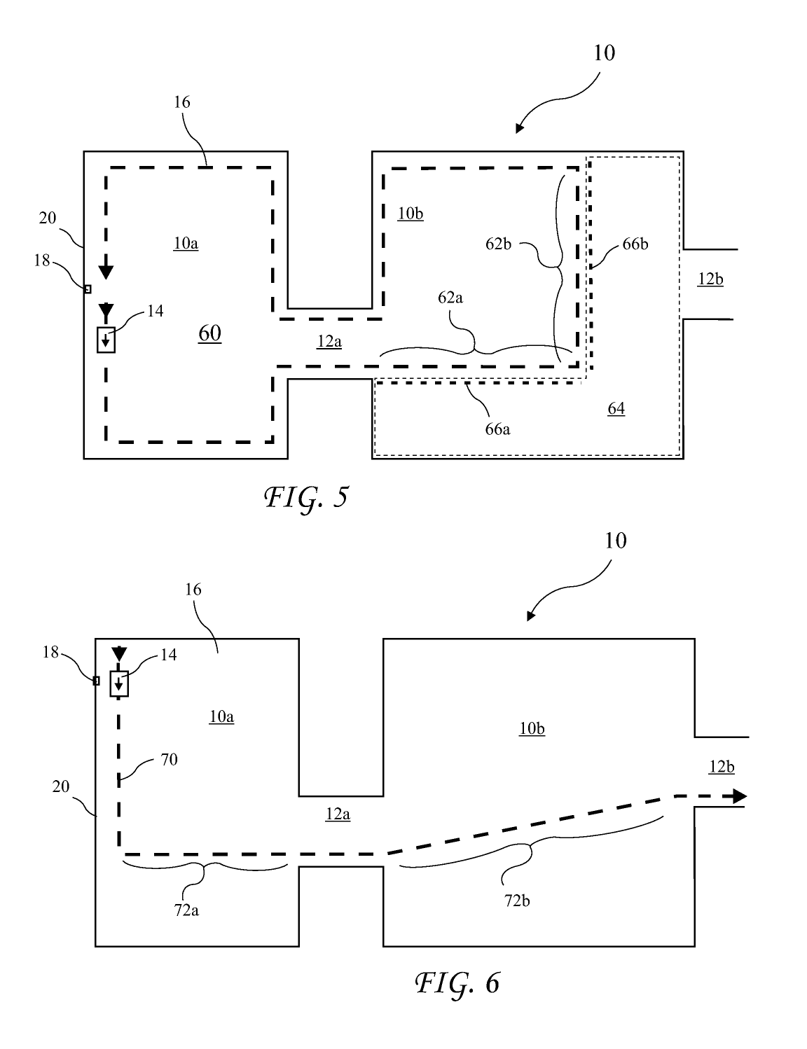

The ROI may also include free run segments 62a, 62b, shown in FIG. 5. The free run segments 62a and 62b are not necessarily associated with detectable features of the room(s) and specifically do not rely on detection of a wall by the sensors 30a and 30b (see FIG. 2) as described in FIGS. 3A-3E. The free run segments 62a and 62b in FIG. 5 create an avoided area 64 set apart by virtual walls 66a and 66b which corresponds to the free run segments 62a and 62b respectively. Such free run segments may be necessary when only part of a corridor or room is intended to come within an ROI. Creation of a free run segment may be selected by the operator or automatically selected by the robotic device 14 when the robotic device recognizes that a wall is not being detected. In this instance, the robotic device 14 uses an alternate method to record a trajectory for the free run segment. Examples of such methods are wheel odometry or tracking the position of the robotic device using the at least one measuring device. The free run segments 62a and 62b may be described as creating a virtual wall offset from the center of the robotic device 14. One advantage of creating a virtual wall is that existing wall following algorithms may directly use the virtual wall for future autonomous operation of the robotic device 14

The present invention has further application to characterizing a Path of Interest (POI) for later autonomous operation. The robotic device 14 is manually driven along the POI from an Initial Point (IP) to a Final Point (FP) and data is collected as when characterizing an ROI. However, in the instance of a POI, the robotic device 14 is not turned back towards the IP, and the operator manually instructs the robotic device that the FP has been reached. One purpose of establishing a POI is to allow separate mapped areas to be linked together whereby the robotic device can autonomously navigate from the first area to be cleaned to the next area.

In the instance of a POI, the free run segments 72a and 72b (see FIG. 6) allow the robotic device to navigate to a different ROI or destination.

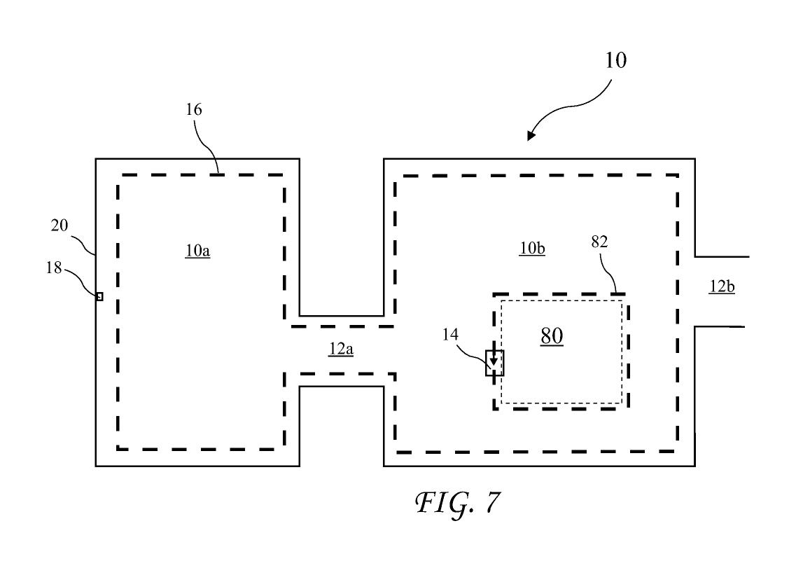

An avoided area 80 comprising an island is shown in FIG. 7. This is one example of a Virtual Walled Area (VWA). The robotic device 14 is driven to a point along the perimeter 82 of the avoided area 80, the operator selects a define avoided area mode, and drives the robotic device 14 around the avoided area 80 to add the avoided area to the ROI.

While the invention herein disclosed has been described by means of specific embodiments and applications thereof, numerous modifications and variations could be made thereto by those skilled in the art without departing from the scope of the invention set forth in the claims.

I claim:

1. A method for establishing a path for operation of a robotic device, the method comprising:
manually positioning the robotic device at an Initial Point (IP) along a first boundary;
manually turning the robotic device to a first heading approximately parallel to the first boundary;
manually driving the robotic device along the first heading approximately parallel to the first boundary;
automatically collecting a set of first data points corresponding to points along the first boundary;
manually turning the robotic device at a first boundary end towards a second heading approximately parallel to a secondary boundary;
automatically fitting a first line to the set of first data points;
manually driving the robotic device along the second heading approximately parallel to the secondary boundary;
automatically collecting a set of second data points corresponding to points along the second boundary;
manually turning the robotic device at a second boundary end;
automatically fitting a second line to the set of second data points;
setting a first corner position to the intersection of the first line and the second line; and
completing manually driving the path and automatically saving the lines and the corners to characterize the path.

2. The method of claim 1, wherein the robotic device includes at least two wheels and the method further including using wheel odometry to measure a distance traveled by the robotic device and measure a heading of the robotic device.

3. The method of claim 2, further including comparing rotations of two of the at least two wheels to measure a change in the heading of the robotic device and combining heading with distance traveled to determine the position and heading of the robotic device.

4. The method of claim 1, wherein fitting the lines to the sets of data points comprises performing a linear regression on each set of data points.

5. The method of claim 1, wherein fitting the lines to the sets of data points comprises performing a linear least squares curve fit on each set of data points.

6. The method of claim 1, wherein completing manually driving the path comprises completing manually driving each segment of a closed path to characterize a Region Of Interest (ROI).

7. The method of claim 1, wherein completing manually driving the path comprises completing manually driving a path between a start point and an end point to characterize a Path Of Interest (POI).

8. The method of claim 1, wherein positioning the robotic device at the IP comprises positioning the robotic device proximal to a machine recognizable feature to identify the starting point of one of an ROI and a POI being characterized for later autonomous operation.

9. The method of claim 8, wherein positioning the robotic device proximal to a machine recognizable feature comprises positioning the robotic device proximal to a Radio Frequency Identification (RFID) tag to identify the starting point of one of an ROI and a POI being characterized for later autonomous operation.

10. The method of claim 1, wherein collecting the set of first data points comprises:
transmitting a sonar signal on a sonar beam pointed towards the first boundary;
receiving a reflection of the sonar signal;
measuring the distance to the first boundary based on a time between transmitting and receiving the sonar signal; and
computing the points along the first boundary based on a position and a heading of the robotic device, the pointing direction of the sonar beam, and the measured distance.

11. The method of claim 1, wherein collecting the set of first data points comprises:
reading distance data from a distance measuring device; and
computing the points along the first boundary based on a position and a heading of the robotic device, the pointing direction of the distance measuring device, and the measured distance.

12. A method for characterizing a Region Of Interest (ROI) defining a number N boundaries, for operation of a robotic device, the method comprising:
positioning the robotic device at an Initial Point (IP) proximal to at least one of a machine recognizable feature and a location identifying tag residing along a first boundary of the ROI;
manually turning the robotic device to a first heading approximately parallel to the first boundary;
manually driving the robotic device along the first heading approximately parallel to the first boundary;
automatically collecting a set of first data points corresponding to points along the first boundary, the first data points determined using a position and a heading of the robotic device and at least one distance measuring sensor carried by the robotic device;
manually turning the robotic device at a first boundary end towards a second heading approximately parallel to a second boundary of the ROI;
automatically fitting a first line to the set of first data points;
manually driving the robotic device along the second heading approximately parallel to the secondary boundary;
automatically collecting a set of second data points corresponding to points along the second boundary, the second data points determined using the position and the heading of the robotic device and the at least one distance measuring sensor carried by the robotic device;
manually turning the robotic device at a second boundary end towards a third heading approximately parallel to a third boundary;
automatically fitting a second line to the set of second data points;
automatically setting a first corner position to the intersection of the first line and the second line;
manually driving the robotic device along the third heading approximately parallel to the third boundary;
completing manually driving remaining boundaries of the ROI, collecting data points, fitting lines, and setting corners; and
saving the characterization of the ROI for later autonomous operation of the robotic device.

13. A method for characterizing a Path Of Interest (POI) defining a number N boundaries, for operation of a robotic device, the method comprising:
positioning the robotic device at an Initial Point (IP) proximal to at least one of a machine recognizable feature and a location identifying tag residing along a first boundary of the POI;
manually turning the robotic device to a first heading approximately parallel to the first boundary;
manually driving the robotic device along the first heading approximately parallel to the first boundary;
automatically collecting a set of first data points corresponding to points along the first boundary, the first data points determined using a position and a heading of the robotic device and at least one distance measuring sensor carried by the robotic device;
manually turning the robotic device at a first boundary end towards a second heading approximately parallel to a second boundary of the POI;
automatically fitting a first line to the set of first data points;
manually driving the robotic device along the second heading approximately parallel to the secondary boundary;
automatically collecting a set of second data points corresponding to points along the second boundary, the second data points determined using the position and the heading of the robotic device and the at least one distance measuring sensor carried by the robotic device;
manually turning the robotic device at a second boundary end towards a third heading approximately parallel to a third boundary;
automatically fitting a second line to the set of second data points;
automatically setting a first corner position to the intersection of the first line and the second line;
manually driving the robotic device along the third heading approximately parallel to the third boundary;
completing manually driving remaining boundaries of the POI, collecting data points, fitting lines, and setting corners; and
saving the characterization of the POI for later autonomous operation of the robotic device.

14. A method for characterizing a Path Of Interest (POI) defining a number N boundaries, for operation of a robotic device, the method comprising:
positioning a robotic device at an Initial Point (IP) proximal to a machine recognizable feature residing along a first boundary of the POI;
manually turning the robotic device to a first heading approximately parallel to the first boundary;
manually driving the robotic device along the first heading;
automatically collecting a set of first data points corresponding to points along the first path, wherein the data points may be determined using a calculated offset distance from the centerline of the machine and a position and heading of the robotic device;
manually turning the robotic device at a first boundary end to a second heading approximately parallel to a second boundary of the POI;
automatically fitting a first line to the set of first data points; manually driving the robotic device along the second heading approximately parallel to the secondary boundary;
automatically collecting a set of second data points corresponding to points along the second boundary, the second data points determined using the position and the heading of the robotic device and a calculated offset distance from the side of the machine carried by the robotic device;
manually turning the robotic device at a second boundary end to a third heading approximately parallel to a third boundary;
automatically fitting a second line to the set of second data points;
automatically setting a first corner position to the intersection of the first line and the second line;
manually driving the robotic device along the third heading approximately parallel to the third boundary;
completing manually driving remaining boundaries of the POI, collecting data points, fitting lines, and setting corners; and
saving the characterization of the POI for later autonomous operation of the robotic device.

15. A method for characterizing a Path Of Interest (POI) defining a number N paths, for operation of a robotic device, the method comprising:
positioning a robotic device at an Initial Point (IP) proximal to a machine recognizable feature residing along a first boundary of the POI;
manually turning the robotic device to a first heading approximately parallel to the first boundary;
manually driving the robotic device along the first heading;
automatically collecting a set of first data points corresponding to points along the first path, wherein the data points may be determined using a calculated offset distance from the centerline of the machine and a position and heading of the robotic device;
manually turning the robotic device at a first heading end.
automatically fitting a first line to the set of first data points;
manually driving the robotic device along the second heading;
automatically collecting a set of second data points corresponding to points along the second heading, using the position and the heading of the robotic device and a calculated offset distance from the side of the machine carried by the robotic device;
manually turning the robotic device at a second heading end to a third heading;
automatically fitting a second line to the set of second data points;
automatically setting a first corner position to the intersection of the first line and the second line;
manually driving the robotic device along the third heading;
completing manually driving remaining headings of the POI, collecting data points, fitting lines, and setting corners; and
saving the characterization of the POI for later autonomous operation of the robotic device.

16. A method for characterizing a Virtual Walled Area (VWA) defining a number N paths, for operation of a robotic device, the method comprising:
positioning a robotic device at an Initial Point (IP) proximal to a machine recognizable feature residing along a first boundary of the POI;
manually turning the robotic device to a first heading approximately parallel to the first boundary;
automatically collecting a set of first data points corresponding to points along the first boundary using a position and a heading of the robotic device and at least one distance measuring sensor carried by the robotic device;
manually turning the robotic device to a second heading;
automatically fitting a line to the first set of points;
manually selecting the virtual wall function;
manually driving the robotic device along the second heading;
automatically collecting a set of second data points corresponding to points along the second path, wherein the data points may be determined using a calculated offset distance from the centerline of the machine and a position and heading of the robotic device;
manually turning the robotic device at a second heading end.
automatically fitting a second line to the set of second data points;
automatically setting a first corner position to the intersection of the first line and the second line;
manually turning the machine to a third heading.
manually selecting the virtual wall function;
automatically collecting a set of third data points corresponding to points along the third heading, using the position and the heading of the robotic device and a calculated offset distance from the side of the machine carried by the robotic device;
manually turning the robotic device at a third heading end;
automatically fitting a third line to the set of third data points;
automatically setting a second corner position to the intersection of the second line and the third line;
manually selecting the virtual wall function;
manually driving the robotic device along the third heading;
completing manually driving remaining headings of the VWA, collecting data points, fitting lines, assigning virtual walls if desired, and setting corners; and
saving the characterization of the VWA for later autonomous operation of the robotic device.
